(19) United States
(12) Patent Application Publication
(10) Pub. No.: US 2022/0077665 A1
(43) Pub. Date: Mar. 10, 2022

(54) WIRE GRIPPER AND METHOD OF USING WIRE GRIPPER

(71) Applicant: NAGAKI SEIKI CO., LTD., Osaka (JP)

(72) Inventor: Masanori GOTO, Kamikita-gun, Aomori (JP)

(21) Appl. No.: 17/312,627

(22) PCT Filed: Nov. 1, 2019
(86) PCT No.: PCT/JP2019/042990

§ 371 Date: Jun. 10, 2021

(30) Foreign Application Priority Data
Dec. 11, 2018 (JP) 2018-231411

(51) Int. Cl. H02G 1/04

(52) U.S. Cl. CPC H02G 1/04

(57) ABSTRACT

The object is to provide a wire gripper that can withstand a high load acting on a lever member of the wire gripper and a method of using the wire gripper. The wire gripper can achieve the object by including: a wire gripper body; a swing member connected to the wire gripper body swingably about a first axis; a lever member connected to the swing member swingably about a second axis; a first pin member inserted through the swing member and the lever member and arranged along the second axis; a reinforcement member configured to be screwed with the first pin member and reinforce the swing member; and a stopper configured to restrict a position of the reinforcement member in a direction along the second axis.

### TECHNICAL FIELD

The present invention relates to a wire gripper and a method of using the wire gripper.

### BACKGROUND ART

Wire grippers that can grip a linear material such as an electric wire are known. For example, a wire gripper is used for pulling an electric wire in order to form a slack part or the like in the electric wire.

As a related art, Patent Literature 1 discloses a wire gripper. In the wire gripper disclosed in Patent Literature 1, a linear material such as an electric wire is gripped by a linear material pressing portion provided to a fixed grasping member and a linear material holding portion provided to a mobile grasping member connected to an activation member. Patent Literature 1 discloses that substantially a triangular activation member and a lever member provided with a pull hole to hang a hook or the like are connected to each other rotatably via a lever member revolving shaft.

### CITATION LIST

### Patent Literature

Patent Literature 1: International Publication No. 2017/119149

### SUMMARY OF INVENTION

### Technical Problem

In general, when a wire gripper maintains tension of a hung electric wire under construction, excessively large force is applied to components forming the wire gripper. The object of the present invention is to provide a wire gripper that can withstand loads applied to a swing member of the wire gripper and a method of using the wire gripper.

### Solution to Problem

The present invention relates to a wire gripper and a method of using the wire gripper as illustrated below.
(1) A wire gripper comprising:

a wire gripper body;

a swing member connected to the wire gripper body swingably about a first axis;

a lever member connected to the swing member swingably about a second axis;

a first pin member inserted through the swing member and the lever member and arranged along the second axis;

a reinforcement member configured to be screwed with the first pin member and reinforce the swing member; and

a stopper configured to restrict a position of the reinforcement member in a direction along the second axis.
(2) The wire gripper according to (1) above, wherein the stopper is a flange portion formed by crimping a tip portion of the first pin member.
(3) The wire gripper according to (1) above, wherein a gap to tolerate swinging between the swing member and the lever member is larger than or equal to 1 mm and smaller than or equal to 1.5 mm.
(4) The wire gripper according to (2) above, wherein a gap to tolerate swinging between the swing member and the lever member is larger than or equal to 1 mm and smaller than or equal to 1.5 mm.
(5) The wire gripper according to (1) above,

wherein the swing member and the lever member are arranged between a head portion of the first pin member and the reinforcement member with a gap to tolerate swinging between the swing member and the lever member being provided between the head portion of the first pin member and the reinforcement member, and

wherein the gap to tolerate swinging between the swing member and the lever member is adjustable by moving the reinforcement member in the direction along the second axis.
(6) The wire gripper according to (2) above,

wherein the swing member and the lever member are arranged between a head portion of the first pin member and the reinforcement member with a gap to tolerate swinging between the swing member and the lever member being provided between the head portion of the first pin member and the reinforcement member, and

wherein the gap to tolerate swinging between the swing member and the lever member is adjustable by moving the reinforcement member in the direction along the second axis.
(7) The wire gripper according to (3) above,

wherein the swing member and the lever member are arranged between a head portion of the first pin member and the reinforcement member with a gap to tolerate swinging between the swing member and the lever member being provided between the head portion of the first pin member and the reinforcement member, and

wherein the gap to tolerate swinging between the swing member and the lever member is adjustable by moving the reinforcement member in the direction along the second axis.
(8) The wire gripper according to (4) above,

wherein the swing member and the lever member are arranged between a head portion of the first pin member and the reinforcement member with a gap to tolerate swinging between the swing member and the lever member being provided between the head portion of the first pin member and the reinforcement member, and

wherein the gap to tolerate swinging between the swing member and the lever member is adjustable by moving the reinforcement member in the direction along the second axis.
(9) The wire gripper according to any one of (1) to (8) above, wherein when a distance between the first axis and the second axis is defined as a distance L3, an intersection between a line connecting the first axis to the second axis and an outer circumference edge of the reinforcement member is defined as an intersection C4 when viewed from a direction perpendicular to a primary face of the reinforcement member, and a distance between the second axis and the intersection C4 is defined as a distance L4, a ratio of the distance L4 to the distance L3 is greater than or equal to 0.2.
(10) A method of using the wire gripper according to any one of (1) to (8) above, the method comprising steps of:

adjusting a gap to tolerate swinging between the swing member and the lever member by moving the reinforcement member in the direction along the second axis; and

after performing a linear material gripping step of gripping a linear material by using the wire gripper, readjusting the gap by moving the reinforcement member in the direction along the second axis.
(11) A method of using the wire gripper according to (9) above, the method comprising steps of:

adjusting a gap to tolerate swinging between the swing member and the lever member by moving the reinforcement member in the direction along the second axis; and

after performing a linear material gripping step of gripping a linear material by using the wire gripper, readjusting the gap by moving the reinforcement member in the direction along the second axis.

### Advantageous Effect of Invention

According to the present invention, it is possible to provide a wire gripper that can withstand high loads applied to a lever member of the wire gripper and a method of using the wire gripper.

### BRIEF DESCRIPTION OF DRAWINGS

FIG. 1 is a schematic two-side view of a wire gripper in a first embodiment.

FIG. 2 is a schematic diagram illustrating a bending load and a torsional load acting on a swing member.

FIG. 3 is a sectional view of FIG. 1 when viewed from an arrow A-A.

FIG. 4 is a diagram illustrating a gap to tolerate swinging between the swing member and a lever member.

FIG. 5 is a diagram illustrating the size of a reinforcement member.

FIG. 6 is a schematic two-side view of the wire gripper in the first embodiment.

FIG. 7 is a schematic perspective view of the wire gripper in the first embodiment.

FIG. 8 is a schematic sectional view of a region near a first pin member.

FIG. 9 is a diagram illustrating an alternative example of a stopper and is a schematic sectional view of a region near the first pin member.

FIG. 10 is a schematic sectional view schematically illustrating an example in which a reinforcement member is arranged around a second pin member.

### DESCRIPTION OF EMBODIMENTS

A wire gripper 1 in the embodiment and a method of using the wire gripper 1 will be described below in detail with reference to the drawings. Note that, in the present specification, members having the same type of function are labeled with the same or similar references. Further, for the members labeled with the same or similar references, duplicated description may be omitted. Note that, in the following description, an example of a case where a linear material gripped by the wire gripper 1 is an electric wire W will be described. However, a linear material gripped by the wire gripper 1 in the embodiment may be any linear material other than the electric wire W. In such a case, the term “electric wire” in the following description will be replaced with “linear material”.

### First Embodiment

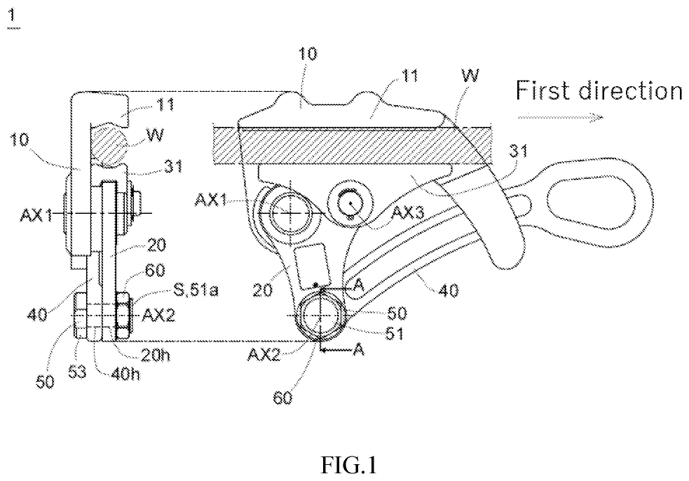

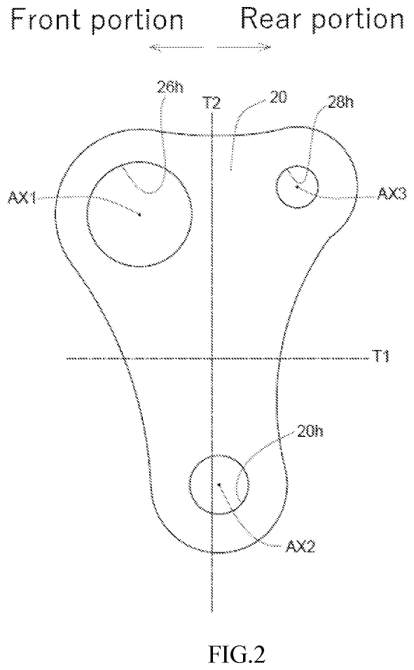

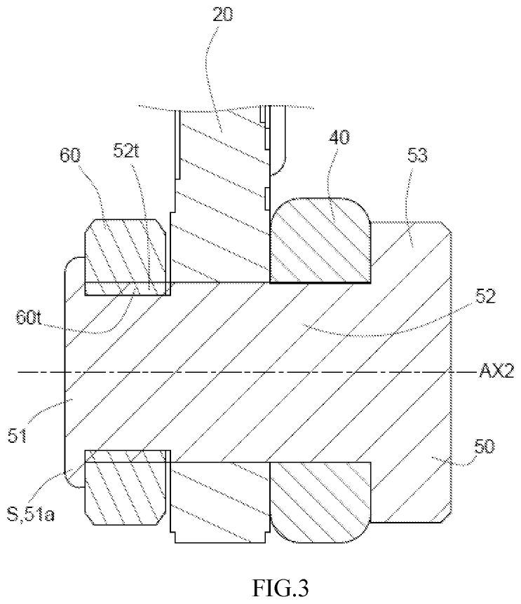

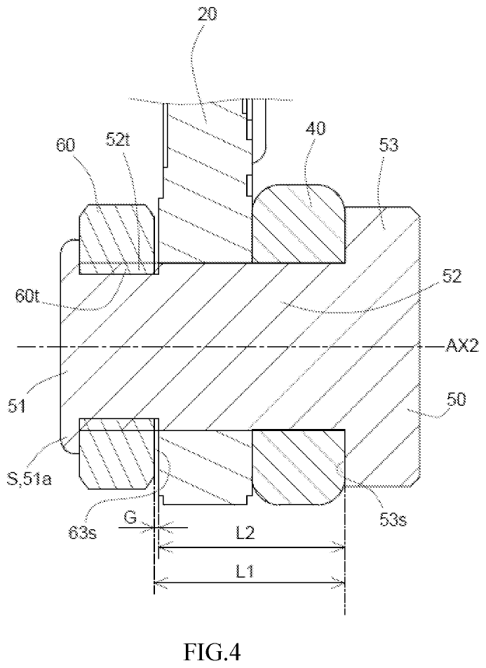

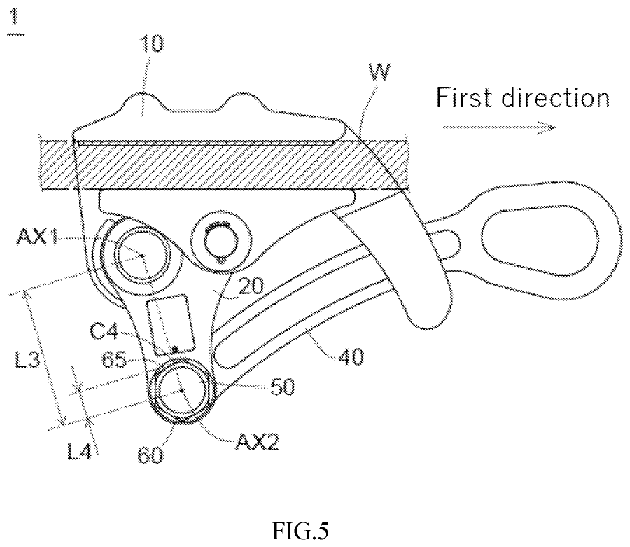

The wire gripper 1 in a first embodiment will be described with reference to FIG. 1 to FIG. 5. FIG. 1 is a schematic two-side view of the wire gripper in the first embodiment. The right side in FIG. 1 illustrates a schematic front view of the wire gripper 1, and the left side in FIG. 1 illustrates a schematic side view of the wire gripper 1. FIG. 2 is a schematic diagram illustrating a bending load and a torsional load acting on a swing member 20. FIG. 3 is a sectional view of FIG. 1 when viewed from the arrow A-A. FIG. 4 is a diagram (sectional view) illustrating a gap G to tolerate swinging between the swing member 20 and a lever member 40. FIG. 5 is a diagram illustrating the size of a reinforcement member 60.

The wire gripper 1 in the first embodiment has a wire gripper body 10, the swing member 20, the lever member 40, a first pin member 50, the reinforcement member 60, and a stopper S.

The wire gripper body 10 has a first gripping piece 11. The wire gripper body 10 may be formed of a single member or may be formed in combination of a plurality of members.

The swing member 20 is connected to the wire gripper body 10 in a swingable manner. Further, the swing member 20 is swingable about a first axis AX1 with respect to the wire gripper body 10.

In the example disclosed in FIG. 1, a second gripping piece 31 is connected to the swing member 20. By reducing the gap between the first gripping piece 11 and the second gripping piece 31, the electric wire W is gripped between the first gripping piece 11 and the second gripping piece 31. On the other hand, by increasing the gap between the first gripping piece 11 and the second gripping piece 31, it is possible to remove the wire gripper 1 from the electric wire W.

In the example disclosed in FIG. 1, the second gripping piece 31 is swingable about a third axis AX3 with respect to the swing member 20.

The lever member 40 is connected to the swing member 20 in a swingable manner. Further, the lever member 40 is swingable about a second axis AX2 with respect to the swing member 20.

The first pin member 50 is a member inserted through the swing member 20 and the lever member 40 and arranged along the second axis AX2. More specifically, the first pin member 50 is arranged so as to pass through a first through hole 20h provided in the swing member 20 and a through hole provided in the lever member 40 (lever member through hole 40h), and the first pin member 50 functions as a swing shaft when the lever member 40 swings with respect to the swing member 20.

As illustrated in FIG. 1, when the lever member 40 is pulled in a first direction (more specifically, a direction substantially parallel to the extending direction of the electric wire W), the swing member 20 swings about the first axis AX1. In response to swinging of the swing member 20, the second gripping piece 31 moves in a direction of approaching the first gripping piece 11, and as a result, the electric wire W is gripped by the first gripping piece 11 and the second gripping piece 31.

In the example illustrated in FIG. 1, when the lever member 40 is pulled in the first direction, a bending load (for example, a bending load around an axial line T1 of FIG. 2) and/or a torsional load (for example, a torsional load around an axial line T2 of FIG. 2) will act on the swing member 20 in addition to a tensile load. An increase in the bending load or the torsional load may cause damage or breakage of the swing member 20.

Accordingly, the wire gripper 1 in the first embodiment has the reinforcement member 60 that reinforces the swing member 20 and the stopper S that restricts the position of the reinforcement member 60 in a direction along the second axis AX2, as illustrated in FIG. 1.

When the swing member 20 is subjected to bending deformation and/or torsional deformation, the swing member 20 presses the reinforcement member 60 directly or indirectly in the direction along the second axis AX2. The reinforcement member 60 applies reaction force directly or indirectly to the swing member 20 against the pressing. In such a way, at least a part of the bending load or the torsional load applied to the swing member 20 is supported by the reinforcement member 60. As a result, damage or breakage of the swing member 20 is prevented even when a high load acts on the lever member 40 to cause bending deformation and/or torsional deformation of the swing member 20.

In the example illustrated in FIG. 1, the reinforcement member 60 is arranged on the swing member 20 side out of the swing member 20 and the lever member 40. Further, the swing member 20 is configured to directly come into contact with the reinforcement member 60 when the swing member 20 is subjected to bending deformation and/or torsional deformation. In such a case, the reinforcing effect of the reinforcement member 60 on the swing member 20 is enhanced. In the first embodiment, however, the reinforcement member 60 may be arranged on the lever member 40 side out of the swing member 20 and the lever member 40. Further, the swing member 20 may be configured to press the reinforcement member 60 indirectly instead of directly when the swing member 20 is subjected to bending deformation and/or torsional deformation.

Further, as illustrated in FIG. 3, the reinforcement member 60 is provided with internal threads 60t configured to be screwed with external threads 52t provided in the outer circumference surface of a shaft portion 52 of the first pin member 50. Thus, the reinforcement member 60 is easily fixed to (screwed with and fixed to) the first pin member 50. Further, it is possible to adjust the position of the reinforcement member 60 (the position of the reinforcement member 60 in the direction along the second axis AX2) only by adjusting the screw-in depth of the reinforcement member 60 relative to the first pin member 50.

Note that, although the reinforcement member 60 is formed of a single member (a single piece) in the example illustrated in FIG. 3, the reinforcement member 60 may be formed of a combination (multiple pieces) of a plurality of members.

The stopper S restricts the position of the reinforcement member 60 in the direction along the second axis AX2. In the example illustrated in FIG. 3, the swing member 20 and the lever member 40 are arranged between the reinforcement member 60 and a head portion 53 of the first pin member 50. Further, in the example illustrated in FIG. 3, the reinforcement member 60 is arranged between the stopper S and the head portion 53 of the first pin member 50 (and between the stopper S and the swing member 20).

In the example illustrated in FIG. 3, the stopper S is a flange portion 51a formed by crimping a tip portion 51 of the first pin member 50. In other words, the stopper S is formed of a part of the first pin member 50. In such a case, since the positional relationship between the head portion 53 of the first pin member 50 and the stopper S is less likely to change (in other words, the position of the stopper S is less likely to vary), the position of the reinforcement member 60 is less likely to shift in the direction along the second axis AX2. In the first embodiment, however, the stopper S may be formed of a separate member from the first pin member 50 instead of being formed as a part of the first pin member 50.

### [Gap G to Tolerate Swinging Between Swing Member 20 and Lever Member 40]

The gap G to tolerates swinging between the swing member 20 and the lever member 40 will be described with reference to FIG. 4. The play between the swing member 20 and the lever member 40, in other words, the gap G to tolerates swinging between the swing member 20 and the lever member 40 can be changed by adjusting the position of the reinforcement member 60 in the direction along the second axis AX2.

More specifically, the gap G means a value obtained by subtracting a sum L2 of thicknesses of a plurality of members (for example, the swing member 20, the lever member 40) arranged between the head portion 53 and the reinforcement member 60 from a distance L1 between a position restriction surface 53s of the head portion 53 of the first pin member 50 and a position restriction surface 63s of the reinforcement member 60. Note that the position restriction surface 53s means a surface facing the reinforcement member 60 (the surface that will come into contact with the lever member 40 in the example illustrated in FIG. 4) out of surfaces of the head portion 53. Further, the position restriction surface 63s means a surface facing the head portion 53 (the surface that will come into contact with the swing member 20 in the example illustrated in FIG. 4) out of surfaces of the reinforcement member 60.

In the first embodiment, the gap G to tolerate swinging between the swing member 20 and the lever member 40 is larger than or equal to 1 mm and smaller than or equal to 1.5 mm, for example. If the gap G is above 1.5 mm, the play between the swing member 20 and the lever member 40 is excessively large, and rattling between the swing member 20 and the lever member 40 may increase. This may result in a reduction in the reinforcing effect of the reinforcement member 60 on the swing member 20. Further, if the gap G is below 1 mm, the play between the swing member 20 and the lever member 40 is excessively small, and swing movement between the swing member 20 and the lever member 40 may be inhibited.

Note that, in the first embodiment, if the wire gripper 1 has the stopper S (for example, the flange portion 51a) that restricts the position of the reinforcement member 60 in the direction along the second axis AX2, this prevents the reinforcement member 60 from moving in the direction along the second axis AX2 (more specifically, a direction away from the head portion 53). This suppresses the gap G described above from being excessively large due to motion of the reinforcement member 60 in the direction away from the head portion 53.

In the example illustrated in FIG. 4, the swing member 20 and the lever member 40 are arranged between the head portion 53 of the first pin member 50 and the reinforcement member 60 with the gap G to tolerate swinging between the swing member 20 and the lever member 40 being provided between the head portion 53 of the first pin member 50 and the reinforcement member 60. Further, in the example illustrated in FIG. 4, the gap G (in other words, the play between the swing member 20 and the lever member 40) can be adjusted by moving the reinforcement member 60 in the direction along the second axis AX2.

Further, in the method of using the wire gripper 1, it is assumed that the play (in other words, the gap G) between the swing member 20 and the lever member 40 may vary between the play obtained before an electric wire gripping step of gripping an electric wire by using the wire gripper 1 is performed and the play obtained after the electric wire gripping step is performed. For example, it is assumed that sliding between the swing member 20 and the lever member 40 causes wearing of a sliding portion of the swing member 20 and/or a sliding portion of the lever member 40 and such wearing causes an increase in the play (in other words, the gap G) between the swing member 20 and the lever member 40. Accordingly, in the example illustrated in FIG. 4, it is possible to readjust the gap G by moving the reinforcement member 60 in the direction along the second axis AX2 (for example, by screwing the reinforcement member 60 into the head portion 53). Note that, if the tip portion 51 of the first pin member 50 is re-crimped to re-mold the flange portion 51a after readjustment of the gap G, the position of the reinforcement member 60 (the position of the reinforcement member 60 in the direction along the second axis AX2) will be restricted by the re-molded flange portion 51a. Note that, when the stopper S that restricts the position of the reinforcement member 60 is a different stopper from the flange portion 51a, the position of the reinforcement member 60 (the position of the reinforcement member 60 in the direction along the second axis AX2) may be restricted by changing the position of the stopper S after readjustment of the gap G.

### [Size of Reinforcement Member 60]

The size of the reinforcement member 60 will be described with reference to FIG. 5. In terms of reinforcing the swing member 20, a larger size of the reinforcement member 60 is preferable. In particular, since a bending load and/or a torsional load may act on the region between the first axis AX1 and the second axis AX2 of the swing member 20, it is preferable that the reinforcement member 60 be arranged so as to widely cover the region between the first axis AX1 and the second axis AX2.

In the example illustrated in FIG. 5, the distance between the first axis AX1 and the second axis AX2 is defined as a distance L3. Further, when viewed from a direction perpendicular to a primary face of the reinforcement member 60 (for example, the position restriction surface 63s), the intersection between a line connecting the first axis AX1 to the second axis AX2 and an outer circumference edge 65 of the reinforcement member 60 is defined as an intersection C4, and the distance between the second axis AX2 and the intersection C4 is defined as a distance L4. In this case, it is preferable that a ratio RT of the distance L4 to the distance L3 (in other words, distance L4/distance L3) be greater than or equal to 0.2 (for example, the ratio RT may be greater than or equal to 0.2 and less than or equal to 0.43). With the ratio RT being greater than or equal to 0.2, the reinforcement member 60 will widely cover the region between the first axis AX1 and the second axis AX2. Note that, when the shape of the outer circumference edge 65 of the reinforcement member 60 is a shape other than a circle, the ratio RT varies in response to rotation of the reinforcement member 60 about the second axis AX2. Thus, in terms of suppressing the variation of the ratio RT, it is preferable that the shape of the outer circumference edge 65 of the reinforcement member 60 be a shape that is point symmetrical about the second axis AX2, such as a circle, a regular polygon (for example, regular hexagon, a regular octagon), or the like.

### Respective Components of Wire Gripper 1 in the First Embodiment

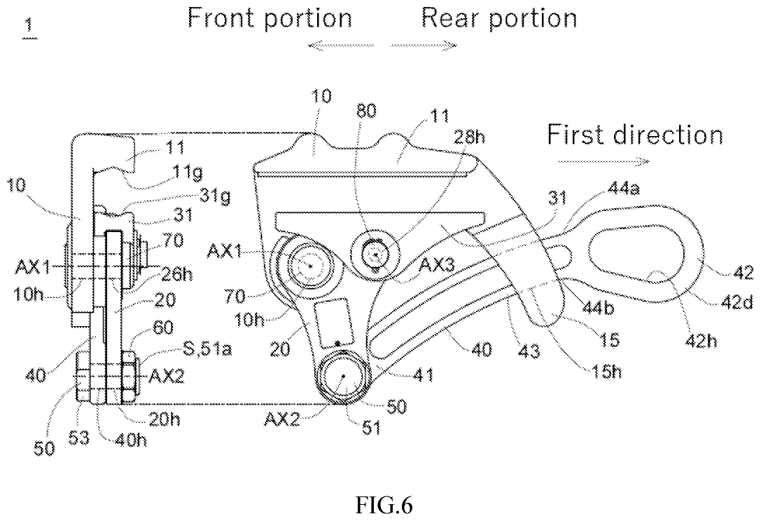

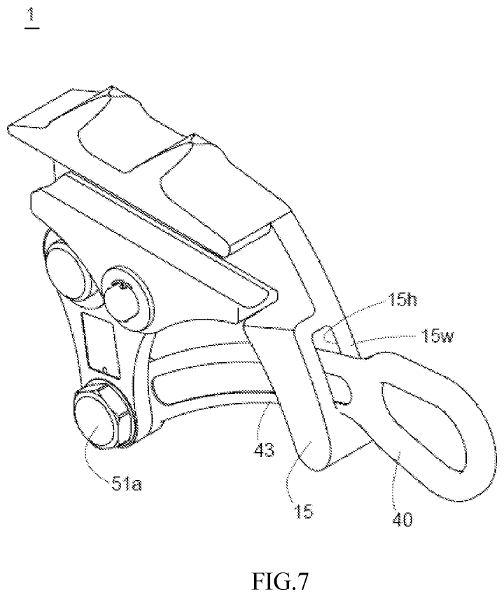

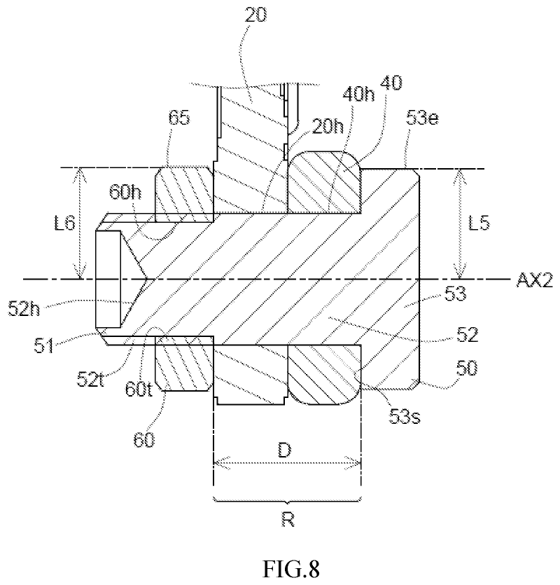

An example of respective components of the wire gripper 1 in the first embodiment will be described with reference to FIG. 6 to FIG. 8. FIG. 6 is a schematic two-side view of the wire gripper 1 in the first embodiment. FIG. 7 is a schematic perspective view of the wire gripper 1 in the first embodiment. FIG. 8 is a schematic sectional view of a region near the first pin member 50. Note that, in the following description, the direction from the first gripping piece 11 to the second gripping piece 31 is referred to as “lower/downward/below”. Further, the direction in which the lever member 40 is pulled so that the gap between the first gripping piece 11 and the second gripping piece 31 decreases is referred to as “rear/rearward” or “first direction”.

### [Wire Gripper Body 10]

In the example disclosed in FIG. 6, the wire gripper body 10 has the first gripping piece 11 and a lever member guide portion 15. The first gripping piece 11 is a portion that comes into contact with the electric wire W from the above, and the lower part of the first gripping piece 11 is provided with a recess groove 11g used for accepting a part of the electric wire W, for example. The extending direction of the recess groove 11g matches the extending direction of the electric wire W.

The lever member guide portion 15 is provided in a rear part of the wire gripper body 10. In the example illustrated in FIG. 6, the vertical position of the lever member guide portion 15 substantially matches the vertical position of the first axis AX1, and the lever member guide portion 15 is arranged on the rear side (first direction side) of the first axis AX1. In the example illustrated in FIG. 6, the lever member guide portion 15 extends downward and rearward from the first gripping piece 11.

The lever member guide portion 15 has a guide wall that guides the lever member 40. In the example illustrated in FIG. 7, the guide wall 15w is a wall that defines a through hole 15h through which an intermediate portion 43 of the lever member 40 is inserted. The lever member guide portion 15 restricts the position of the lever member 40, thereby suppresses the lever member 40 from excessively shifting in the horizontal direction (the direction perpendicular to the sheet of FIG. 6), and as a result, suppresses an excessive load from acting on a connecting portion between the lever member 40 and the swing member 20.

The wire gripper body 10 is provided with a through hole 10h used for inserting a second pin member 70 therethrough that connects the wire gripper body 10 and the swing member 20 in a swingable manner. The through hole 10h is provided in the lower portion in the front portion (in other words, the portion on the opposite side to the first direction) of the wire gripper body 10, for example.

### [Swing Member 20]

The swing member 20 is a plate-like member extending in the direction perpendicular to the second axis AX2, for example. The swing member 20 has, for example, a tapered shape whose width decreases from the upper to the lower in the front view (see the right drawing in FIG. 6). More specifically, in the example illustrated in FIG. 6, the swing member 20 has substantially a triangular shape in the front view. Note that the shape of the swing member 20 is not limited to the shape illustrated in FIG. 6. As the shape of the swing member 20, any shape may be employed as long as it can be connected to the wire gripper body 10 in a swingable manner and can be connected to the lever member 40 in a swingable manner.

The swing member 20 is provided with a second through hole 26h used for inserting the second pin member 70 therethrough. For example, the second through hole 26h is provided at the upper end of the front portion (in other words, the portion on the opposite side to the first direction) of the swing member 20 (see FIG. 2 if necessary). The center axis of the second through hole 26h (in other words, the center axis of the second pin member 70) matches the first axis AX1.

The swing member 20 is provided with the first through hole 20h used for inserting the first pin member 50 therethrough. For example, the first through hole 20h is provided at the lower end of the swing member 20 (see FIG. 2 if necessary). The center axis of the first through hole 20h (in other words, the center axis of the first pin member 50) matches the second axis AX2.

In the example illustrated in FIG. 6, the swing member 20 is provided with a third through hole 28h used for inserting a third pin member 80 therethrough. Note that the third pin member 80 is a pin member that connects the swing member 20 and the second gripping piece 31 to each other swingably about the third axis AX3. The third through hole 28h is provided at the upper end of the rear portion (in other words, the portion on the first direction side) of the swing member 20, for example. The center axis of the third through hole 28h (in other words, the center axis of the third pin member 80) matches the third axis AX3. Note that, in the example illustrated in FIG. 2, the first through hole 20h is arranged at one of the apex portions of substantially the triangular swing member 20, the second through hole 26h is arranged at another apex portion of substantially the triangular swing member 20, and the third through hole 28h is arranged at the remaining apex portion of substantially the triangular swing member 20. Note that the center axis of the first through hole 20h and the center axis of the second through hole 26h are parallel, and the center axis of the first through hole 20h and the center axis of the third through hole 28h are parallel.

### [Second Gripping Piece 31]

In the example illustrated in FIG. 6, the second gripping piece 31 is supported by the swing member 20 swingably about the third axis AX3. The second gripping piece 31 is a member that comes into contact with the electric wire W from the below, and the upper part of the second gripping piece 31 is provided with a recess groove 31g used for accepting a part of the electric wire W, for example. The extending direction of the recess groove 31g matches the extending direction of the electric wire W. The second gripping piece 31 is arranged below the first gripping piece 11, and the electric wire W is gripped by the first gripping piece 11 from the above and by the second gripping piece 31 from the below.

The second gripping piece 31 is provided with a through hole used for inserting the third pin member 80 therethrough.

### [Lever Member 40]

The lever member 40 has a first end 41 connected to the swing member 20 in a swingable manner and a second end 42 that is a free end. The lever member 40 is an elongated member extending upward and rearward from the connecting portion to the swing member 20 (in other words, from the second axis AX2). In the example illustrated in FIG. 6, the lever member 40 has an arc shape, and a convex surface 44a having the arc shape is located above a concave surface 44b having the arc shape.

The second end 42 of the lever member 40 is provided with a mounting portion 42d used for mounting a pulled member such as a wire material, a bar material, or the like. In the example illustrated in FIG. 6, the mounting portion 42d is a ring portion having a through hole 42h.

The first end 41 of the lever member 40 is provided with a through hole (lever member through hole 40h) through which the first pin member 50 is inserted.

### [First Pin Member 50]

In the example illustrated in FIG. 8, the first pin member 50 has the head portion 53 and the shaft portion 52 extending in the direction along the second axis AX2 from the head portion 53. The external threads 52t configured to be screwed with the internal threads 60t of the reinforcement member 60 are formed in the outer circumference surface of the shaft portion 52. Further, a recess 52h recessed toward the head portion 53 is formed at the free end of the shaft portion 52. The presence of the recess 52h enables easier crimping processing of the free end of the shaft portion 52. However, the recess 52h may be omitted.

The maximum value of a distance L5 from the second axis AX2 to the outer circumference edge 53e of the head portion 53 is, for example, around 14 mm (larger than or equal to 13.5 mm and smaller than or equal to 15 mm).

The diameter of the shaft portion 52 is, for example, around 18 mm (larger than or equal to 15 mm and smaller than or equal to 25 mm). In the shaft portion 52, the region provided with the external threads 52t is a region that can be screwed with the reinforcement member 60, and the position of the reinforcement member 60 can be adjusted within a range of the region provided with the external threads 52t. When the sum of the thickness of the lever member 40 and the thickness of the swing member 20 is defined as D, no external threads 52t may be provided in the region R within the distance D from the position restriction surface 53s of the head portion 53. Because the region R is a non-threaded region, the play between the swing member 20 and the lever member 40 is reliably ensured. However, the external threads 52t may be formed in substantially the whole outer circumference surface of the shaft portion 52.

To fix the reinforcement member 60 to the first pin member 50, first, the shaft portion 52 of the first pin member 50 is inserted in the first through hole 20h of the swing member 20 and the lever member through hole 40h of the lever member 40, and second, the internal threads 60t of the reinforcement member 60 are screwed with the external threads 52t provided in the shaft portion 52, and the position of the reinforcement member 60 in the direction along the second axis AX2 is adjusted. Then, the position of the reinforcement member 60 in the direction along the second axis AX2 is restricted by the stopper S. For example, this position restriction is performed by crimping the tip portion 51 of the first pin member 50 to form the flange portion 51a (see FIG. 3 if necessary).

### [Reinforcement Member 60]

The reinforcement member 60 has a through hole 60h through which the first pin member 50 is inserted, and the internal threads 60t configured to be screwed with the external threads 52t are formed in the internal wall defining the through hole 60h. The thickness of the reinforcement member 60 (the thickness in the direction along the second axis AX2) is around 10 mm (larger than or equal to 8 mm and smaller than or equal to 13 mm). Further, the maximum value of a distance L6 from the second axis AX2 to the outer circumference edge 65 of the reinforcement member 60 is, for example, around 15 mm (larger than or equal to 12 mm and smaller than or equal to 25 mm). Note that the maximum value of the distance L6 may be larger than the maximum value of the distance L5 or may be substantially the same as the maximum value of the distance L5.

In the wire gripper 1 in the embodiment, the swing member 20 is reinforced by the reinforcement member 60. Thus, it is also possible to use the wire gripper 1 in the embodiment when gripping and pulling an electric wire having a relatively large diameter (for example, an electric wire having a diameter of 20 mm or larger). When an electric wire having a relatively large diameter (for example, an electric wire having a diameter of 20 mm or larger) is gripped and pulled, a load of about 10 tons or more may act on the lever member 40 of the wire gripper. Since the swing member 20 is reinforced by the reinforcement member 60 in the embodiment, the swing member 20 will not be destroyed even when such a high load acts on the lever member 40 and the swing member 20.

It is clear that the present invention is not limited to the embodiment described above and the embodiment can be modified or changed as appropriate within the scope of the technical concept of the present invention. Further, any component may be omitted in the embodiment.

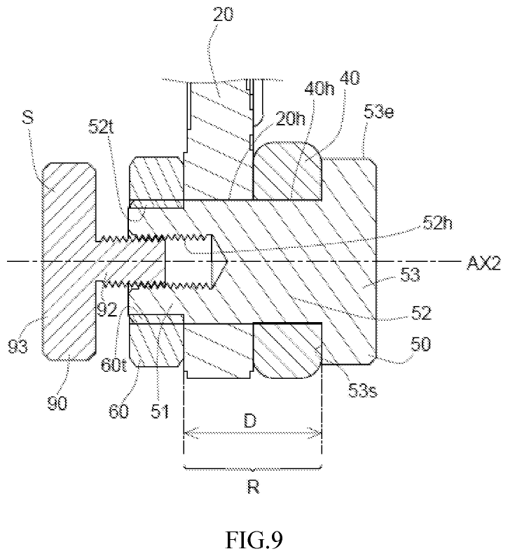

For example, in the embodiment described above, the example in which the stopper S is the flange portion 51a formed by crimping the tip portion 51 of the first pin member 50 has been described. Alternatively, as illustrated in FIG. 9 as an example, the stopper S that restricts the position of the reinforcement member 60 in the direction along the second axis AX2 may be a stopper member 90 mounted to the first pin member 50.

In the example illustrated in FIG. 9, the stopper member 90 has a head portion 93 that restricts the position of the reinforcement member 60 and a shaft portion 92. In the example illustrated in FIG. 9, external threads are formed in the outer circumference surface of the shaft portion 92, and these external threads are screwed with internal threads formed in the inner circumference surface of the first pin member 50. More specifically, in the example illustrated in FIG. 9, the recess 52h recessed toward the head portion 53 is formed at the free end of the shaft portion 52 of the first pin member 50, and the external threads formed in the outer circumference surface of the shaft portion 92 are screwed with the internal threads formed in the recess 52h.

In the example illustrated in FIG. 9, the stopper member 90 is mounted to the first pin member 50 by screwing the stopper member 90 into the first pin member 50. In such a way, the stopper member 90 restricts the position of the reinforcement member 60 in the direction along the second axis AX2.

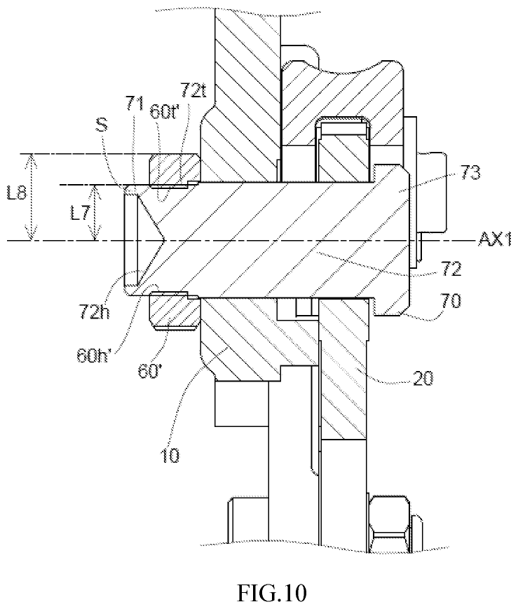

Further, in the embodiment described above, the example in which the reinforcement member 60 has the through hole 60h through which the first pin member 50 is inserted and the reinforcement member 60 arranged around the first pin member 50 reinforces the swing member 20 has been described. Alternatively or additionally, as illustrated in FIG. 10 as an example, a reinforcement member 60′ may have a through hole 60h′ through which the second pin member 70 is inserted, and the reinforcement member 60′ arranged around the second pin member 70 may be configured to reinforce the swing member 20.

In the example illustrated in FIG. 10, the reinforcement member 60′ is arranged on the wire gripper body 10 side out of the swing member 20 and the wire gripper body 10. Further, the swing member 20 is configured to come into contact with the reinforcement member 60 indirectly via the wire gripper body 10 when the swing member 20 is subjected to bending deformation and/or torsional deformation. In the embodiment, however, the reinforcement member 60′ may be arranged on the swing member 20 side out of the swing member 20 and the wire gripper body 10. In such a case, the reinforcement member 60′ may be configured to be able to directly come into contact with the swing member 20.

In the example illustrated in FIG. 10, the reinforcement member 60′ is provided with internal threads 60t′ configured to be screwed with the external threads 72t provided in the outer circumference surface of the shaft portion 72 of the second pin member 70. Thus, the reinforcement member 60′ is easily fixed to (screwed with and fixed to) the second pin member 70. Further, it is possible to adjust the position of the reinforcement member 60′ (the position of the reinforcement member 60′ in the direction along the first axis AX1) only by adjusting the screw-in depth of the reinforcement member 60′ relative to the second pin member 70.

In the example illustrated in FIG. 10, the second pin member 70 has a head portion 73 and a shaft portion 72 extending in the direction along the first axis AX1 from the head portion 73. External threads 72t configured to be screwed with the internal threads 60t′ of the reinforcement member 60′ are formed in the outer circumference surface of the shaft portion 72. Further, a recess 72h recessed toward the head portion 73 is formed at the free end of the shaft portion 72. The presence of the recess 72h enables easier crimping processing of the free end of the shaft portion 72. However, the recess 72h may be omitted.

In the example illustrated in FIG. 10, the stopper S is a flange portion formed by crimping the tip portion 71 of the second pin member 70. Alternatively, in the same manner as the example illustrated in FIG. 9, the stopper S that restricts the position of the reinforcement member 60′ in the direction along the first axis AX1 may be the stopper member 90 mounted to the second pin member 70. Since the stopper member 90 has already been described with reference to FIG. 9, duplicated description for the stopper member 90 will be omitted.

In the example illustrated in FIG. 10, in the shaft portion 72 of the second pin member 70, the radius of the portion to which the reinforcement member 60′ is mounted is defined as a radius L7. Further, the minimum distance between the outer circumference edge of the reinforcement member 60′ and the first axis AX1 is defined as a distance L8. In this case, it is preferable that a ratio RT2 of the radius L7 to the distance L8 (in other words, distance L8/radius L7) be greater than or equal to 1.25 and less than or equal to 1.75. With the ratio RT2 being greater than or equal to 1.25, the reinforcement member 60′ can effectively reinforce the swing member 20. Further, with the ratio RT2 being smaller than or equal to 1.75, interference between the reinforcement member 60′ and another member is suppressed. In other words, the presence of the reinforcement member 60′ will not be an obstacle.

### INDUSTRIAL APPLICABILITY

With the use of the wire gripper and the method of using the wire gripper of the present invention, it is possible not only to perform an operation of gripping an electric wire having a relatively small diameter but also to perform an operation of gripping an electric wire having a relatively large diameter. Therefore, the present invention is useful for business entities that use a wire gripper to perform their operations and manufacturers that manufacture wire grippers.

### LIST OF REFERENCES

1 wire gripper
10 wire gripper body
10h through hole
11 first gripping piece
11g recess groove
15 lever member guide portion
15h through hole
15w guide wall
20 swing member
20h first through hole
26h second through hole
28h third through hole
31 second gripping piece
31g recess groove
40 lever member
40h lever member through hole
41 first end
42 second end
42d mounting portion
42h through hole
43 intermediate portion
44a convex surface
44b concave surface
50 first pin member
51 tip portion
51a flange portion
52 shaft portion
52h recess
52t external threads
53 head portion
53e outer circumference edge
53s position restriction surface
60, 60′ reinforcement member
60h, 60h′ through hole
60t, 60t′ external threads
63s position restriction surface
65 outer circumference edge
70 second pin member
71 tip portion
72 shaft portion
72h recess
72t external threads
73 head portion
80 third pin member
90 stopper member
92 shaft portion
93 head portion
AX1 first axis
AX2 second axis
AX3 third axis
S stopper
W electric wire

1. A wire gripper comprising:
a wire gripper body;
a swing member connected to the wire gripper body swingably about a first axis;
a lever member connected to the swing member swingably about a second axis;
a first pin member inserted through the swing member and the lever member and arranged along the second axis;
a reinforcement member configured to be screwed with the first pin member and reinforce the swing member; and
a stopper configured to restrict a position of the reinforcement member in a direction along the second axis.

2. The wire gripper according to claim 1, wherein the stopper is a flange portion formed by crimping a tip portion of the first pin member.

3. The wire gripper according to claim 1, wherein a gap to tolerate swinging between the swing member and the lever member is larger than or equal to 1 mm and smaller than or equal to 1.5 mm.

4. The wire gripper according to claim 2, wherein a gap to tolerate swinging between the swing member and the lever member is larger than or equal to 1 mm and smaller than or equal to 1.5 mm.

5. The wire gripper according to claim 1,
wherein the swing member and the lever member are arranged between a head portion of the first pin member and the reinforcement member with a gap to tolerate swinging between the swing member and the lever member being provided between the head portion of the first pin member and the reinforcement member, and
wherein the gap to tolerate swinging between the swing member and the lever member is adjustable by moving the reinforcement member in the direction along the second axis.

6. The wire gripper according to claim 2,
wherein the swing member and the lever member are arranged between a head portion of the first pin member and the reinforcement member with a gap to tolerate swinging between the swing member and the lever member being provided between the head portion of the first pin member and the reinforcement member, and
wherein the gap to tolerate swinging between the swing member and the lever member is adjustable by moving the reinforcement member in the direction along the second axis.

7. The wire gripper according to claim 3,
wherein the swing member and the lever member are arranged between a head portion of the first pin member and the reinforcement member with a gap to tolerate swinging between the swing member and the lever member being provided between the head portion of the first pin member and the reinforcement member, and
wherein the gap to tolerate swinging between the swing member and the lever member is adjustable by moving the reinforcement member in the direction along the second axis.

8. The wire gripper according to claim 4,
wherein the swing member and the lever member are arranged between a head portion of the first pin member and the reinforcement member with a gap to tolerate swinging between the swing member and the lever member being provided between the head portion of the first pin member and the reinforcement member, and
wherein the gap to tolerate swinging between the swing member and the lever member is adjustable by moving the reinforcement member in the direction along the second axis.

9. The wire gripper according to claim 1, wherein when a distance between the first axis and the second axis is defined as a distance L3, an intersection between a line connecting the first axis to the second axis and an outer circumference edge of the reinforcement member is defined as an intersection C4 when viewed from a direction perpendicular to a primary face of the reinforcement member, and a distance between the second axis and the intersection C4 is defined as a distance L4, a ratio of the distance L4 to the distance L3 is greater than or equal to 0.2.

10. A method of using the wire gripper according to claim 1, the method comprising steps of:
adjusting a gap to tolerate swinging between the swing member and the lever member by moving the reinforcement member in the direction along the second axis; and
after performing a linear material gripping step of gripping a linear material by using the wire gripper, readjusting the gap by moving the reinforcement member in the direction along the second axis.

11. A method of using the wire gripper according to claim 9, the method comprising steps of:
adjusting a gap to tolerate swinging between the swing member and the lever member by moving the reinforcement member in the direction along the second axis; and
after performing a linear material gripping step of gripping a linear material by using the wire gripper, readjusting the gap by moving the reinforcement member in the direction along the second axis.

12. The wire gripper according to claim 2, wherein when a distance between the first axis and the second axis is defined as a distance L3, an intersection between a line connecting the first axis to the second axis and an outer circumference edge of the reinforcement member is defined as an intersection C4 when viewed from a direction perpendicular to a primary face of the reinforcement member, and a distance between the second axis and the intersection C4 is defined as a distance L4, a ratio of the distance L4 to the distance L3 is greater than or equal to 0.2.

13. The wire gripper according to claim 3, wherein when a distance between the first axis and the second axis is defined as a distance L3, an intersection between a line connecting the first axis to the second axis and an outer circumference edge of the reinforcement member is defined as an intersection C4 when viewed from a direction perpendicular to a primary face of the reinforcement member, and a distance between the second axis and the intersection C4 is defined as a distance L4, a ratio of the distance L4 to the distance L3 is greater than or equal to 0.2.

14. The wire gripper according to claim 4, wherein when a distance between the first axis and the second axis is defined as a distance L3, an intersection between a line connecting the first axis to the second axis and an outer circumference edge of the reinforcement member is defined as an intersection C4 when viewed from a direction perpendicular to a primary face of the reinforcement member, and a distance between the second axis and the intersection C4 is defined as a distance L4, a ratio of the distance L4 to the distance L3 is greater than or equal to 0.2.

15. The wire gripper according to claim 5, wherein when a distance between the first axis and the second axis is defined as a distance L3, an intersection between a line connecting the first axis to the second axis and an outer circumference edge of the reinforcement member is defined as an intersection C4 when viewed from a direction perpendicular to a primary face of the reinforcement member, and a distance between the second axis and the intersection C4 is defined as a distance L4, a ratio of the distance L4 to the distance L3 is greater than or equal to 0.2.

16. The wire gripper according to claim 6, wherein when a distance between the first axis and the second axis is defined as a distance L3, an intersection between a line connecting the first axis to the second axis and an outer circumference edge of the reinforcement member is defined as an intersection C4 when viewed from a direction perpendicular to a primary face of the reinforcement member, and a distance between the second axis and the intersection C4 is defined as a distance L4, a ratio of the distance L4 to the distance L3 is greater than or equal to 0.2.

17. The wire gripper according to claim 7, wherein when a distance between the first axis and the second axis is defined as a distance L3, an intersection between a line connecting the first axis to the second axis and an outer circumference edge of the reinforcement member is defined as an intersection C4 when viewed from a direction perpendicular to a primary face of the reinforcement member, and a distance between the second axis and the intersection C4 is defined as a distance L4, a ratio of the distance L4 to the distance L3 is greater than or equal to 0.2.

18. The wire gripper according to claim 8, wherein when a distance between the first axis and the second axis is defined as a distance L3, an intersection between a line connecting the first axis to the second axis and an outer circumference edge of the reinforcement member is defined as an intersection C4 when viewed from a direction perpendicular to a primary face of the reinforcement member, and a distance between the second axis and the intersection C4 is defined as a distance L4, a ratio of the distance L4 to the distance L3 is greater than or equal to 0.2.

19. A method of using the wire gripper according to claim 2, the method comprising steps of:
adjusting a gap to tolerate swinging between the swing member and the lever member by moving the reinforcement member in the direction along the second axis; and
after performing a linear material gripping step of gripping a linear material by using the wire gripper, readjusting the gap by moving the reinforcement member in the direction along the second axis.

20. A method of using the wire gripper according to claim 3, the method comprising steps of:
adjusting a gap to tolerate swinging between the swing member and the lever member by moving the reinforcement member in the direction along the second axis; and
after performing a linear material gripping step of gripping a linear material by using the wire gripper, readjusting the gap by moving the reinforcement member in the direction along the second axis.
